(19) United States
(12) Patent Application Publication
(10) Pub. No.: US 2026/0353437 A1
(43) Pub. Date: Nov. 5, 2026

(54) Negotiation of a Duration of a Physical Layer Protocol Data Unit (PPDU) used in Multi-AP Coordinated Transmission

(71) Applicant: NXP USA, Inc., AUSTIN, TX (US)

(72) Inventor: Rui Cao, Sunnyvale, CA (US)

(21) Appl. No.: 19/398,407

(22) Filed: Nov. 24, 2025

Related U.S. Application Data
(60) Provisional application No. 63/798,359, filed on May 1, 2025.

(51) Int. Cl. H04W 74/04; H04W 84/12

(52) U.S. Cl. CPC H04W 74/04; H04W 84/12

(57) ABSTRACT

Multi-access point (AP) coordination during a transmit opportunity (TXOP) in accordance with Institute of Electrical and Electronics Engineers (IEEE) 802.11 protocol includes transmitting by a sharing AP an initial control frame (ICF) to indicate a coordinated beamforming (CBF) request; receiving, by the sharing AP, an initial control response from a shared AP which indicates to perform the coordinated beamforming; transmitting by the sharing AP a CBF trigger frame which causes the shared AP and sharing AP to transmit respective CBF physical layer protocol data units (PPDUs) to associated stations; and receiving, by the shared AP, an respective acknowledgement from the associated stations to the CBF PPDUs based on a block acknowledgement request.

### CROSS-REFERENCE TO RELATED APPLICATIONS

This application is entitled to the benefit of Indian Provisional Patent Application Serial Number IN202541010625, titled “CO-ORDINATED BF TRANSMISSION EXCHANGES WITHIN TXOP” which was filed Feb. 7, 2025, US Provisional Patent Application Serial Number IN202541013439, titled “CO-ORDINATED BF TRANSMISSION EXCHANGES WITHIN TXOP AND CORRESPONDING SIGNALING” which was filed Feb. 17, 2025, and U.S. Provisional Patent Application Ser. No. 63/800,854, titled “MULTI-AP COORDINATED TRANSMISSION: TRIGGER FRAME DESIGN” which was filed May 6, 2025, the contents each of which are incorporated herein by reference in its entirety.

### FIELD OF USE

The present disclosure relates generally to multi-access point (AP) coordinated beamforming, and more particularly, to a system, method, and apparatus for defining a frame exchange sequence between a sharing access point (AP) and shared AP and between the APs and associated stations during coordinated beamforming compliant with Institute of Electrical and Electronics Engineers (IEEE) 802.11bn or Ultra High Reliability (UHR) used in multi-AP coordinated transmission.

### BACKGROUND

Institute of Electrical and Electronics Engineers (IEEE) 802.11bn or Ultra High Reliability (UHR) defines a Multi-AP coordination process where multiple independent access points (APs) coordinate transmissions to associated client stations (STA). Coordinated beamforming (CBF) is one example of a spatial multi-AP coordination where interference between the transmissions by a plurality of APs is reduced by the plurality of APs using beamforming to simultaneously transmit physical layer protocol data units (PPDUs) to associated STA by sharing transmit opportunity (TXOP) resources with reduced interference between transmissions. Multi-AP coordination improves network performance by efficient sharing of a frequency spectrum.

### BRIEF DESCRIPTION OF THE DRAWINGS

The following detailed description of the preferred embodiments of the present disclosure will be better understood when read in conjunction with the appended drawings.

The present disclosure is illustrated by way of example, and not limited by the accompanying figures, in which like references indicate similar elements.

FIG. 1 illustrates an example block diagram of a wireless network arranged to perform multi-AP coordinated beamforming (CBF) transmissions in accordance with one or more embodiments.

FIG. 2 illustrates example communication between the sharing AP and shared AP to facilitate the CBF in a transmit opportunity (TXOP) in accordance with one or more embodiments.

FIG. 3 illustrates an example trigger frame format that defines a format of one or more of control frames and a CBF trigger frame in accordance with one or more embodiments.

FIGS. 4(a), 4(b) illustrate example fields defining a format of an initial control frame (ICF) frame in accordance with one or more embodiments.

FIG. 5 illustrates example fields defining a format of an initial control response (ICR) frame in accordance with one or more embodiments.

FIG. 6 illustrates example fields of the CBF trigger frame including a user information field in accordance with one or more embodiments.

FIG. 7 illustrates other examples of a user information field of the CBF trigger frame in accordance with one or more embodiments.

FIG. 8 illustrates yet other examples of a user information field of the CBF trigger frame in accordance with one or more embodiments.

FIG. 9 illustrates other examples of a user information field of the CBF trigger frame in accordance with one or more embodiments.

FIG. 10 is a flow chart of functions associated with defining a frame exchange sequence between a sharing AP and shared AP for CBF transmission and between the APs and associated stations for CBF transmission accordance with one or more embodiments.

### DETAILED DESCRIPTION

The detailed description of the appended drawings is intended as a description of the currently preferred embodiments of the present disclosure, and is not intended to represent the only form in which the present disclosure may be practiced. It is to be understood that the same or equivalent functions may be accomplished by different embodiments that are intended to be encompassed within the spirit and scope of the present disclosure.

Embodiments disclosed herein are directed to defining a frame exchange sequence between a sharing AP and shared AP for coordinated beamforming (CBF) transmission and between the APs and associated stations. The sharing AP shares a transmit opportunity (TXOP) with the shared AP during the CBF. Frames transmitted between the sharing AP and shared AP during the TXOP include exchange of media access control frames and in particular exchange of control frames such an initial control frame (ICF) and initial control response (ICR) between the sharing AP and shared AP as defined by IEEE 802.11 and a CBF trigger frame transmitted by the sharing AP and received by the shared AP for each to trigger transmission of one or more PPDUs to associated stations. The ICF generally carries parameters of the sharing AP while the ICR generally carries parameters of the shared AP. The CoBF trigger frame define parameters of the PPDUs transmitted to associated stations. The sharing AP and shared AP transmit PPDUs in response to the trigger frame to associated STAs and receive transmission of acknowledgment frames by the associated STAs to acknowledge receipt of the PPDUs in accordance with a protocol to perform CBF in the TXOP. In one or more embodiments, the shared AP transmits a block acknowledgement request (BAR) to associated stations and receives acknowledgements from associated stations after a time that the sharing AP receives respective acknowledgement from associated stations. Well known instructions, protocols, structures, and techniques have not been shown in detail in order not to obfuscate the description.

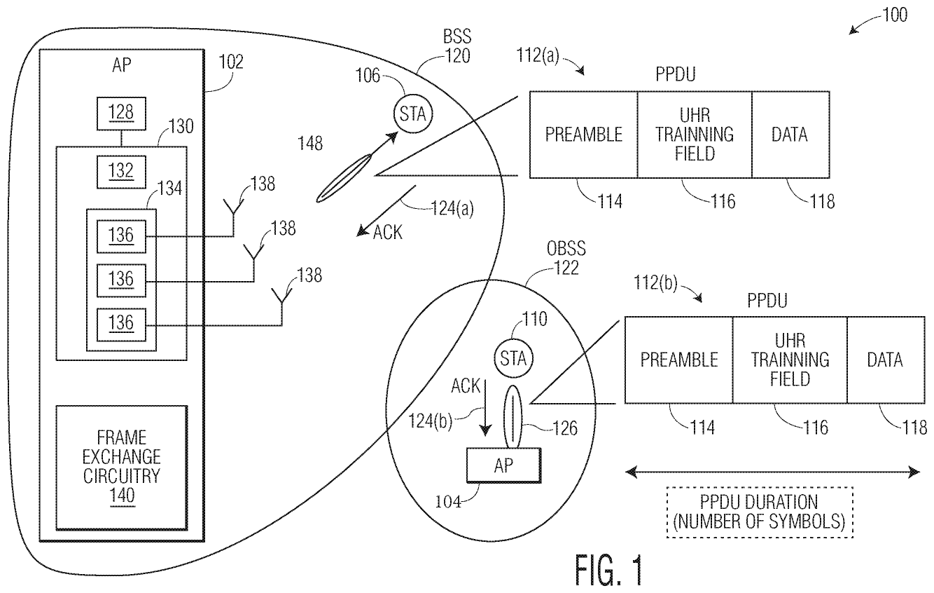

FIG. 1 illustrates an example block diagram of a wireless network 100 arranged to perform multi-AP coordinated transmissions in accordance with one or more embodiments. The wireless network 100 includes two access points (APs) 102, 104 each associated with a station (STA). For example, STA 106 is associated with AP 102 and STA 110 is associated with AP 104. The wireless network 100 may include more than two APs and one or more associated station for each AP and the number of APs and stations shown in the wireless network 100 is for illustrative purposes only. In an embodiment, the station (STA) is a fixed or mobile wireless terminal and the AP may be a networking device which facilitates connecting the station to a wired network (not shown). The AP or STA may also be referred to generally as wireless devices. An access point (AP) may communicate with one or more associated stations in a downlink or uplink direction. The downlink (i.e., forward link) direction is communication from the access point to the stations, and the uplink (i.e., reverse link) direction is communication from the stations to the access point. A station is associated with an AP when it has successfully connected to and is communicating with the AP based on an association process which includes the station sending an association request to the AP and the AP responding with an association response as defined by Institute of Electrical and Electronics Engineers (IEEE) 802.11.

The AP 102 includes a host processor 128 coupled to a network interface 130. The host processor 128 may enable the AP 102 to transmit and receive signals as described herein. The network interface 130 includes a medium access control (MAC) processing unit 132 and a physical layer (PHY) processing unit 134. The PHY processing unit 134 includes a plurality of transceivers 136 (e.g., transmitters and/or receivers) and the transceivers 136 are coupled to a respective antenna 138 for transmitting or receiving wireless signals. Although three transceivers and three antennas are illustrated, the AP 102 includes other suitable numbers (e.g., 1, 2, 4, 5, etc.) of transceivers and antennas in other embodiments. In one or more embodiments, the MAC processing unit 132 and the PHY processing unit 134 are configured to operate according to a communication protocol such as Institute of Electrical and Electronics Engineers (IEEE) 802.11 WiFi standard. Although not shown, the AP 104 and STA 106, 110 may have a similar structure and components including a respective processor and network interface. The wireless devices and components described therein to perform the described functions herein may be implemented as one or more of analog circuitry, mixed signal circuitry, memory circuitry, logic circuitry, and processing circuitry that execute code stored in a memory that when executed by the processing circuitry performs the disclosed functions.

Each AP may be identified as either a sharing AP or shared AP. For example, AP 102 may be a sharing AP while AP 104 may be a shared AP. The sharing AP may be an access point which shares a bandwidth of a wireless medium and associated resources such as a transmit opportunity (TXOP) with the one or more shared AP in addition to facilitating communication with an associated station while the shared AP uses the shared bandwidth of the wireless medium and resources to facilitate communication with an associated station. TXOP or Transmission Opportunity, is a bounded time interval where a connected station is able to transmit a sequence of frames consecutively without interruption to associated stations. The sharing AP is an owner of a transmit opportunity (TXOP) and allows other shared APs to use the TXOP of the sharing AP to transmit data during the TXOP.

Institute of Electrical and Electronics Engineers (IEEE) 802.11bn or Ultra High Reliability (UHR) defines a Multi-AP coordination process where multiple independent access points (APs) coordinate respective transmission to associated client stations (STA). Coordinated beamforming (CBF) is one example of a multi-AP coordination where interference between the transmissions by a plurality of APs and associated STA is reduced by the plurality of APs simultaneously transmitting in time and in frequency physical layer protocol data units (PPDUs) to associated STA using beamforming in a shared transmit opportunity (TXOP). Beamforming is a signal processing technique used in wireless communication and other systems to focus a transmitted signal in a specific direction, rather than broadcasting the transmitted signal in all directions. Transmissions of each of the antenna 138 may be weighted to focus the transmitted signal in the specific direction and improve signal reception at a receiver. The APs 102, 104 may perform beamforming compliant with Institute of Electrical and Electronics Engineers (IEEE) 802.11bn or Ultra High Reliability (UHR). Multi-AP coordination improves network performance by efficient sharing of a frequency spectrum.

In one or more embodiments, the transmission between an AP and associated STA may be a physical layer protocol data unit (PPDU) transmitted from an AP to associated STA. Shared AP 104 may transmit a PPDU 112(b) to associated STA 110 while sharing AP 102 may transmit a PPDU 112(a) to associated STA 106. The PPDU 112(a), 112(b) defined by IEEE 802.11 UHR may each have a preamble 114, a UHR training field 116, and a data field 118 to facilitate transmissions and have a PPDU duration defined by a number of orthogonal frequency division multiple access (OFMDA) symbols.

Embodiments disclosed herein are directed to defining a frame exchange sequence between a sharing AP and shared AP for CBF transmission between the APs and associated stations. The sharing AP shares a transmit opportunity (TXOP) with the shared AP. Further, the shared AP and sharing AP may have respective CBF frame exchange circuitry 140. The CBF frame exchange circuitry 140 defines a protocol for a sequence of frame exchanges performed by the shared AP and sharing AP to transmit the PPDUs 112(a), 112(b) and to receive transmission of acknowledgment frames 124(a), 124(b) by the associated STAs to acknowledge receipt of the PPDUs.

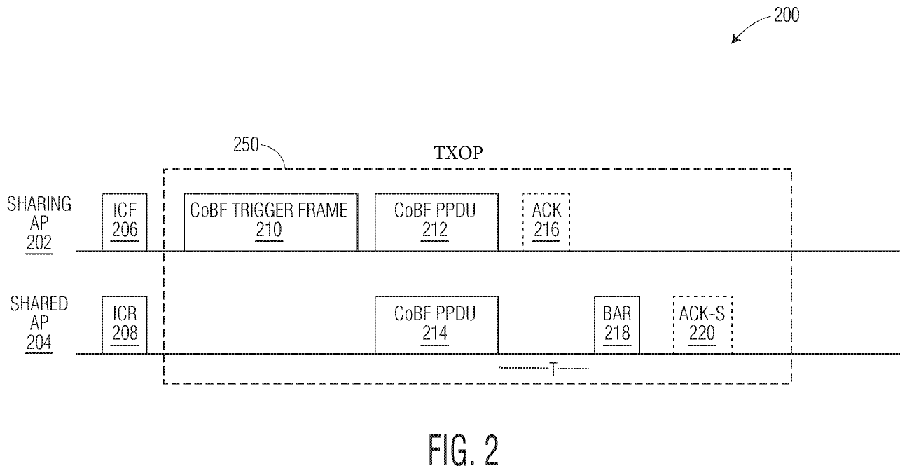

FIG. 2 illustrates example communication 200 between the sharing AP 202 and shared AP 204 to facilitate the CBF in a TXOP 250 in accordance with one or more embodiments. The sharing AP 202 may reserve the communication medium and share the TXOP 250 with a shared AP 204. Then, the sharing AP 202 may enter into a configuration phase and exchange handshaking signals with the shared AP 204. For example, when one AP (the “sharing AP”) initiates CBF transmission, it sends an invite frame 206 defined by IEEE 802.11 to another AP (the “shared AP”) to indicate a CBF request. In one or more embodiments, the invite frame 206 may be a control frame such as an initial control frame (ICF) corresponding to a coordinated beamforming (CoBF) invite defined by IEEE 802.11. The ICF may carry one or more parameters such as a packet extension (PE) Disambiguity of a CBF PPDU transmitted by the sharing AP to associated stations for interpreting a packet extension of the CBF PPDU, a phy version ID of the CBF PPDU, a number of users/stations associated with the sharing AP, use of a guard interval and long training field (LTF) in the CBF PPDU, and user specific fields including a station ID and a number of spatial streams used by an associated station/user of the sharing AP. In one or more embodiments, a response frame 208 to the invite frame 206 may be a control frame such an initial control response (ICR) frame corresponding to a coordinated beamforming (CoBF) response defined by IEEE 802.11 which indicates by a response that the shared AP is to perform the CBF. The ICR may carry one or more parameters including a number of user/stations associated with the shared AP, an extra long training field (LTF) used in a CBF PPDU transmitted by the shared AP to associated stations, user/station specific fields such as a station ID of stations associated with the shared AP, a modulation and coding scheme (MCS), a number of spatial streams used by the associated station, indication of use of a 2×1944 low density parity check code (LDPC), and a bit to indicate participation in transmitting the CBF PPDU to associated stations. In some embodiments, the shared AP 204 and sharing AP 202 may transmit one or more exchanges of the ICF and ICR which are not shown for conciseness.

A CBF transaction may be performed by the sharing AP 202 and shared AP 204 to transmit data to associated STA using CBF. The sharing AP 202 may construct a trigger frame 210 to convey from the sharing AP 202 to the shared AP 204 common announcement signals and define fields of a CBF PPDU 212, 214 to be transmitted by an AP to associated STA and information associated with the CBF. The information and fields may include one or more of an agreed CoBF PPDU duration, a phy version ID of the PPDU, a bandwidth of the PPDU, a total number of user/stations between the sharing AP and shared AP, a guard interval (GI) and LTF of the PPDU, a number of extra LTF to be used in the PPDU, an LPDC extra symbol segment to be used in the PPDU, and user/station specific fields including a spatial configuration of a station associated with the sharing and shared AP and indication of use of 2×LDPC. The CBF PPDU 212, 214 transmitted by an AP may also include the data of the AP to be transmitted to the associated STA along with an indication for an STA which receives the CBF PPDU to transmit an acknowledgment frame 216, 220 to the CBF PPDU 212, 214 which indicates to the AP that an STA received the PPDU. In an embodiment, the sharing AP 202 may transmit the CBF trigger frame 210 to the shared AP 204 to begin the CBF. Based on the transmission, the sharing AP 202 and shared AP 204 may transmit respective CBF PPDUs 212, 214 to associated STA. Based on the receipt of a CBF PPDU, the STA associated with the sharing AP may transmit a respective acknowledgment 216 which is received by the sharing AP 202 and the STA associated with the shared AP 204 may transmit a respective acknowledgment 220 to the shared AP 204. This process may be repeated for one or more CBF transactions.

In one or more embodiments, the STAs associated with the sharing AP 202 may transmit the respective acknowledgment 216 to the received CBF PPDU 212. After receiving the acknowledgement 216 from associated STA, the shared AP 204 may transmit a block acknowledgment request (BAR) 218 to the associated STA and the associated STAs may transmit the respective acknowledgment 220 to the CBF PPDU 214 that it received from the shared AP 204. A multi-user block acknowledgement request (BAR) is used to perform multiuser block acknowledgment in one uplink (UL) multiuser transmission for a wireless communications protocol. The request may be for the stations associated with the shared AP to acknowledge a frame of the PPDU based on a BAR field of the BAR. The BAR 218 is an indication for an STA send an acknowledgment 222 of frames of the CBF PPDU 214 received by the STA. In an embodiment, a packet duration of the acknowledgment 216 transmitted by the STA associated with the sharing AP 202 might be pre-negotiated during the ICF-ICR exchange so that the shared AP 204 will know a time T when the respective acknowledgments 216 from the sharing AP's STAs have been received after transmission of the CBF PPDU 212. The time T may be a predetermined time that the shared AP waits before transmitting the BAR 218 and in some embodiments be a duration of the ACK 216 or the duration of the ACK 216 and a short interframe space (SIFS) interval. After the time T the shared AP may transmit the BAR 218. Then, the associated STA of the shared AP may transmit in response to the BAR 218 the respective acknowledgments 220 to the CBF PPDU 214 that it received from the shared AP 204.

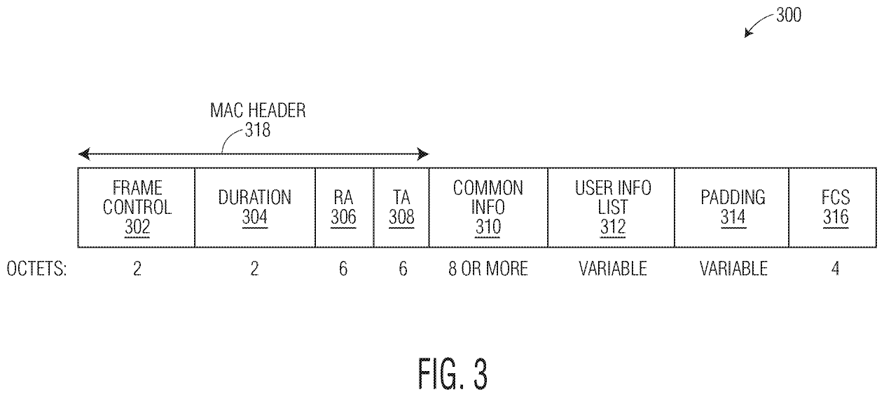

FIG. 3 illustrates an example trigger frame 300 that defines a format of one or more of the ICF, ICR, and CBF trigger frame. The trigger frame 300 may include a plurality of fields including a frame control field 302, a duration field 304, a receiver address (RA) field 306 (e.g., shared AP address), a transmitter address (TA) field 308 (e.g., sharing AP address), a common information field 310, a user information list field 312, a padding field 314, and a frame check sequence (FCS) 316. The RA may indicate a shared AP's address (which is not a broadcast address) and the TA may indicate a sharing AP's address. In an embodiment, the fields may define a media access control header 318 of the trigger frame 300. The common information field 310 may indicate information common to a plurality of users identified by information in the user information list field 312. The users may be stations of APs in one or more embodiments.

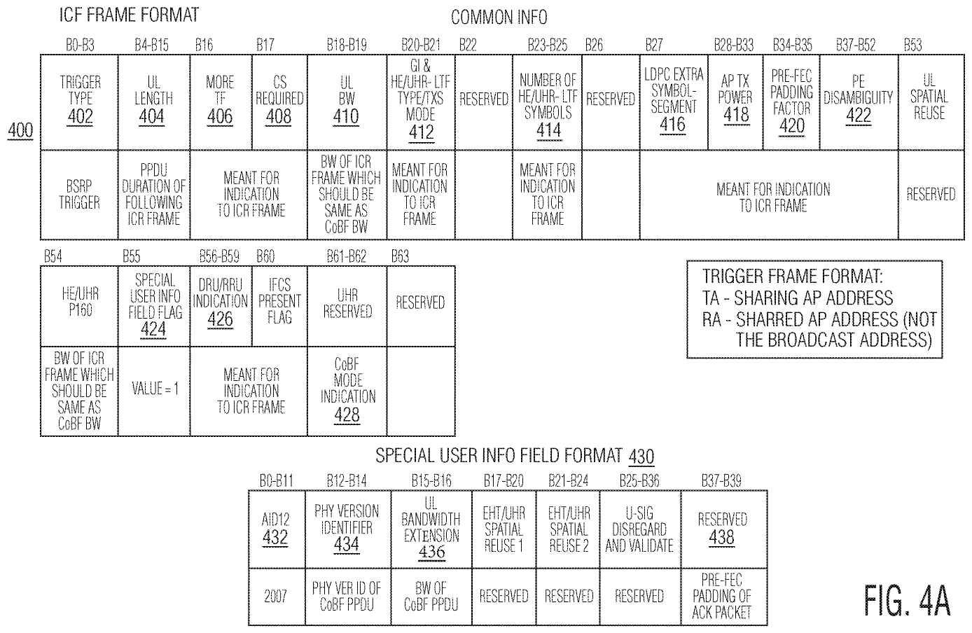

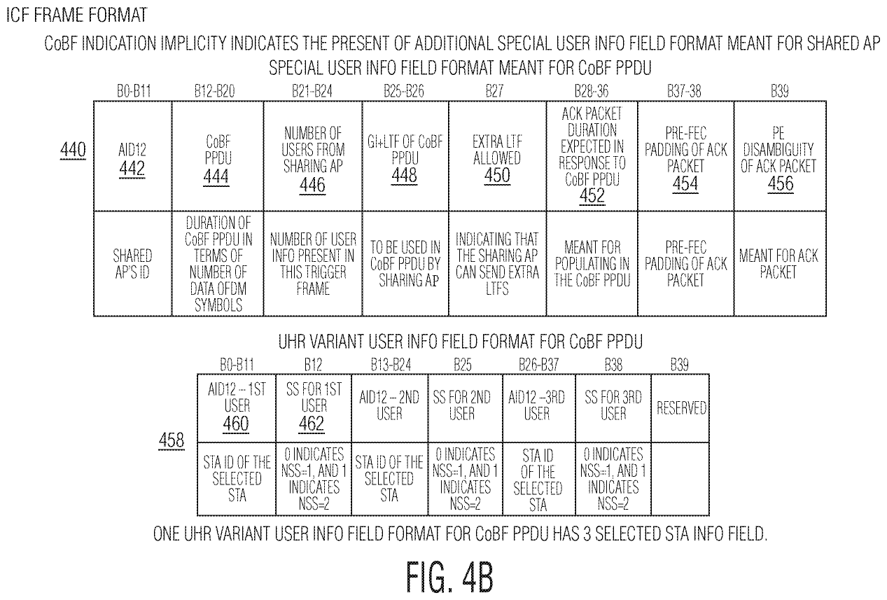

FIG. 4(a), 4(b) illustrate example common information fields defining a format of an ICF frame 400 in accordance with one or more embodiments. ICF frame 400 may have a field 402 that indicates a format of the ICF. The field 402 may indicate the ICF has a format corresponding to a Buffer Status Report Poll (BSRP) Trigger frame format or BSRP non-trigger based format defined by IEEE 802.11. A UL length field 404 may indicate a PPDU duration of the CBF PPDU which is transmitted in response to the trigger frame. A more trigger frame 406 and carrier sense required field 408 may indicate whether a trigger frame follows the ICR frame and carrier sense is required for the ICR respectively. An uplink bandwidth field 410 may indicate the bandwidth of the ICR frame is to be the same as the CBF PPDU. The guard interval (GI) and long training field (LTF) type field 412 may indicate a GI and LTF type of the ICR. The number of LTF symbols field 414 may indicate a number of LTF for the ICR. The number of LPDC extra symbols segment, AP transmit power, pre-forward error correction (FEC) padding factor, and PE disambiguity may be defined for the ICR in respective fields 416-422. A special user information field 424 may be set to one to indicate presence of a special user information field. The ICF frame 400 may also have an UHR reserved field 428 in the common information field having a CoBF indication which indicates CoBF operation. The ICR frame may have a distributed resource unit (DRU) or regular resource unit (RRU) indicated in field 426 of the ICR frame.

In one or more embodiment, a special user info field 430 identified by an AID 2007 in an AID12 field 432 contains additional information of the CBF PPDU such as a PHY Version Identifier field 434 having a version of a CBF PPDU, UL bandwidth field 436 which indicates a bandwidth of the CBF PPPU, and a reserved field 438 which indicates whether pre-FEC padding is to be added to an acknowledgment packet.

In one or more embodiment, a special user info field 440 contains additional information meant for the CBF PPDU transmitted by the shared AP such as an AID12 field 442 indicating a shared AP ID, a CBF PPPU field 444 which indicates a duration of the CBF PPDU in terms of a number of OFDM data symbols, a number of user/stations associated with the sharing AP field 446 which indicates a number of user fields present in the ICF, a GI LTF field 448 to indicate the guard interval (GI) LTF of the PPDU of the sharing AP, an extra LTF allowed field 450 to indicate whether the sharing AP sends extra LTF, an acknowledgement duration T expected in the response to the CBF PPDU field 452 which is populated in the CBF PPDU, a pre-FEC padding of acknowledgement packet field 454 which indicates pre-FEC padding of the acknowledgment packet, and a PE Disambiguity of the acknowledgment packet field 456 indicating the PE Disambiguity of the acknowledgment packet.

In one or more embodiment, the ICF may include a user information field 458 which defines information of the CBF PPDU. The user information field 458 may have an AID12 field 460 which has a station identifier which indicates a selected station and a number of spatial streams field 462 which indicates a number of spatial streams used by a station with the station identifier. The selected station may be a station associated with the sharing AP which will participate in the CBF. The user information field 458 may include similar information for a plurality of stations such as three stations and the information is included in the PPDU. The station for which the user information is provided may be a station associated with the sharing AP in an embodiment.

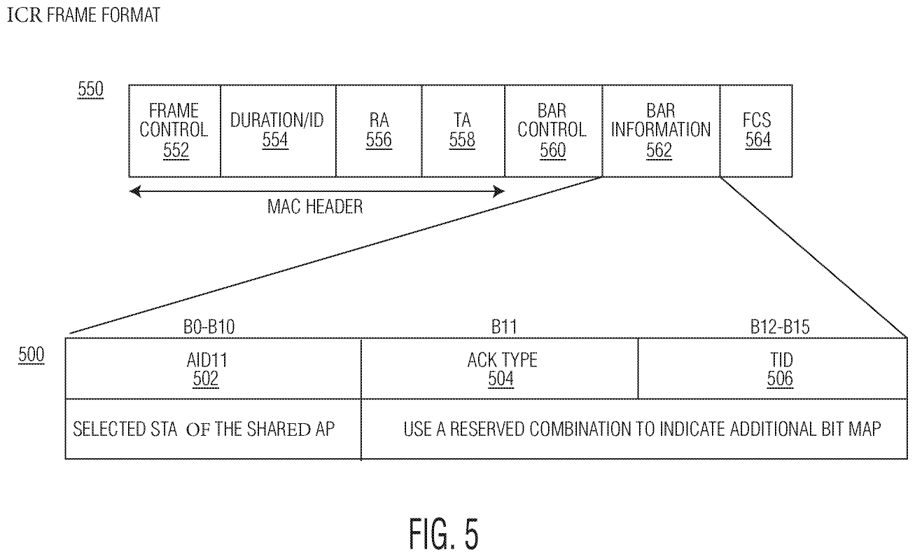

FIG. 5 illustrates example fields defining a format of an ICR 500 in accordance with one or more embodiments. The ICR 500 may have a multi-STA block acknowledgment format comprising one or more fields including a frame control field 552, a duration field 554, a receiver address field 556, a transmitter address field 558, a block acknowledgment Response (BAR) control field 560, a BAR information field 562, and an FCS field 564. The BAR information field 562 of the ICR 550 may include an AID11 field 502, an acknowledgment type field 504 and a traffic identifier (TID) field 506. The AID11 field 502 may identify an STA selected by the shared AP and associated with the shared AP participating in the CBF. The selected station may be a station associated with the shared AP which will participate in the CBF. The acknowledgement type field 504 and TID field 506 may define a combination of bits of reserved entries which indicate additional information of the STA associated with the shared AP to be transmitted to the sharing AP in the ICR 550. In one embodiment, the per STA information in fields 504, 506 include a number of spatial streams (Nss) field which indicates by one bit a Nss, MCS field which indicates an MCS using 5 bits, and a two times low density parity check code (2×LDPC) to indicate whether the station uses 2×LDPC. One octet of an additional bit map may be required to handle these data. In another embodiment, the per STA information in fields 504, 506 include a CoBF PPDU duration in a 9 bit field, extra long training field (LTF) which is a 1 bit field to indicate whether the shared AP is to use the LTF, and number of users associated with the shared AP field which indicates in 3 bits a number of users associated with the shared AP. Two octets of an additional bit map may be required to handle these data.

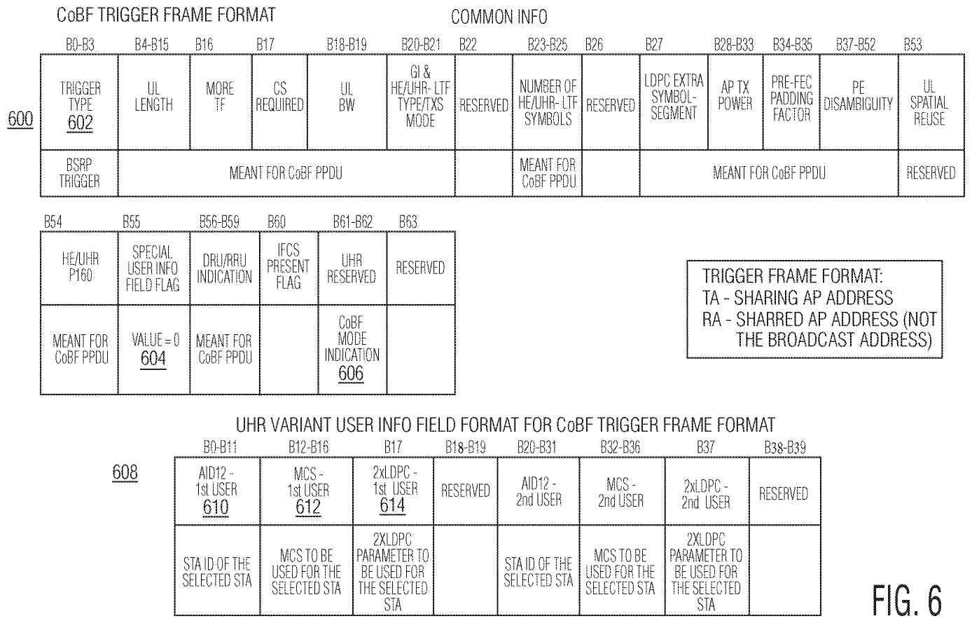

FIG. 6 illustrates example fields of the CBF trigger frame 600 including a user information field in accordance with one or more embodiments. The CBF trigger frame 600 has a format of the BSRP trigger or BSRP non-trigger based format defined by IEEE 802.11 and indicated by the trigger type field 602. The CBF trigger frame 600 may include a special user information field flag 604. A UHR reserved field 606 may indicate the CBF trigger frame 600 is for a CBF mode. If the special user info field flag 604 is not set (i.e., 0) and the UHR reserved field 606 indicates the CBF mode, then the BSRP trigger frame is the CBF trigger frame 600, User information field 608 of the trigger frame 600 may include fields with information for one or more stations (where a station device is a user) associated with the sharing AP and shared AP selected for CBF participating in the CBF. Each station may be identified by a station identifier in an AID12 field 610 of an STA selected by the sharing AP or shared AP and include for the station in an MCS field 612 a modulation and coding scheme (MCS) and two times low density parity check code (2×LDPC) field 614 which indicates an 2×LDPC parameter for the station.

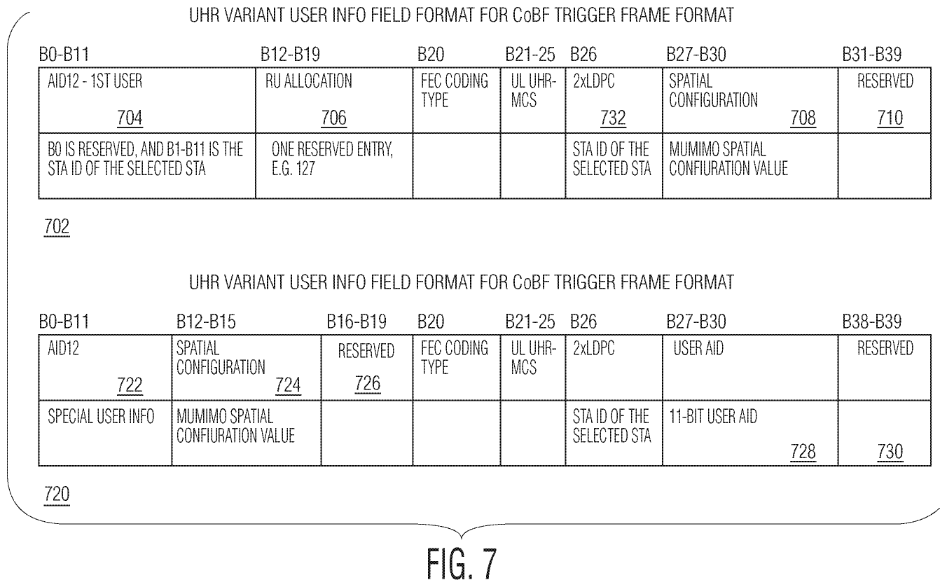

FIG. 7 illustrates other examples of a user information field of the CBF trigger frame 600 in accordance with one or more embodiments. In one embodiment, a per user information field 702 may include an AID12 field 704 identifying a first user (i.e., selected STA participating in the CBF), a resource unit (RU) allocation field 706 having one reserved entry to indicate that the first user associated with the per-user information field 702 is a multi-AP (MAP) user (i.e., station associated with coordinated APs), a spatial configuration field 708 (4 bits) which indicates a multi-user multiple input multiple output (MU-MIMO) spatial configuration (i.e., number of spatial streams allocated to the STA) followed by a reserved field 710 which reserves bits for further usage in the future. In some embodiments, a 2×LDPC field 732 may indicate a station ID of the selected station. In another embodiment, a per user information field 720 may include an AID12 field 722 which has a special AID to indicate the per user information field 720 is for a multi-AP (MAP) user, a spatial configuration field 724 which indicates a MU-MIMO spatial configuration, a reserved field 726, a user AID field 728 which indicates an 11 bit user AID of the user associated with the per user information field 720, and a reserved field 730.

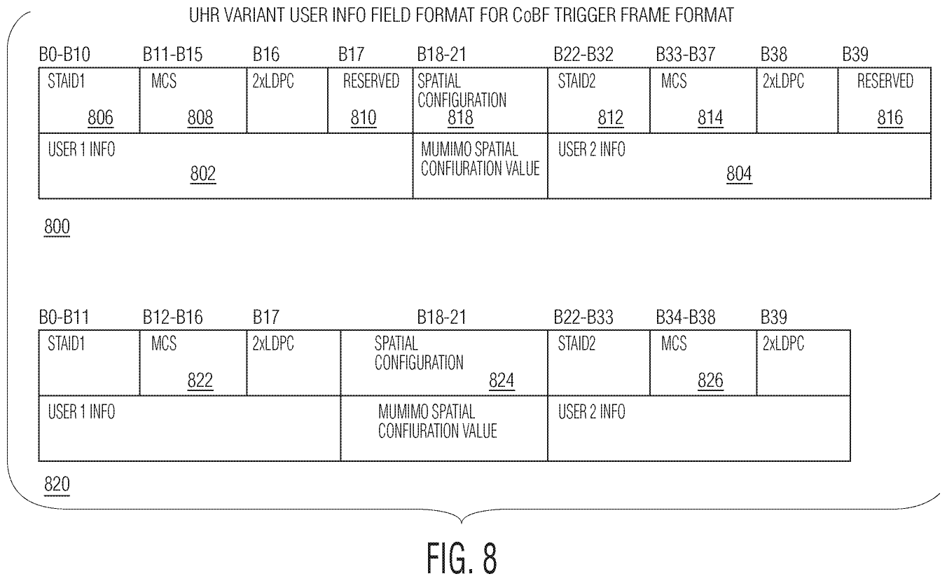

FIG. 8 illustrates yet other examples of a user information field of the CBF trigger frame 600 in accordance with one or more embodiments. In one embodiment, a user information field 800 which is 40 bits may define fields to carry user information for two users, e.g., stations associated with the sharing or shared AP participating in the CBF. The user information field 800 may include user 1 information fields 802 and user information 2 fields 804. Further, the user information field 800 may include a station identification field 806 to identify a first user, an MCS field 808 and reserved field 810 and the user 2 information field 804 may include a station identification field 812 to identify a second user, an MCS field 814 and reserved field 816. A coding bit may be added to the reserved field 810, 816 to indicate presence of a coding (e.g., FEC). Further, the user information field 800 may include a spatial configuration field 818 which defines a MU-MIMO spatial configuration value for both users. In some embodiments, a number of users for which user information is to be transmitted may be odd in which case bits B22-B39 may be reserved or the STAID2 may be used to indicate “no user.” In another embodiment, a user information field 820 which is 40 bits may define fields to carry user information for two users. The user information field 820 may include an MCS field 822, 826 for each user and a spatial configuration field 824 defining the MU-MIMO spatial configuration for both users.

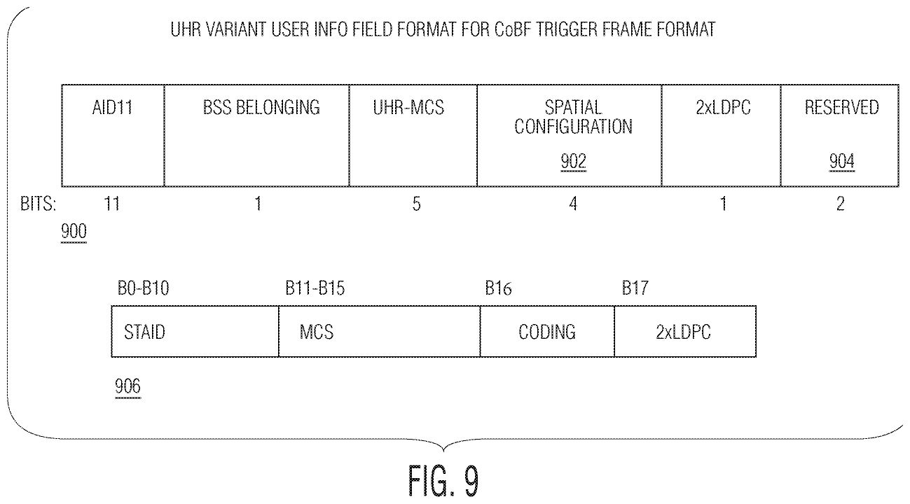

FIG. 9 illustrates other examples of a user information field of the CBF trigger frame 600 in accordance with one or more embodiments. In one embodiment, a per-user information field 900 may be 24 bits and include a spatial configuration field 902 which is four bits which indicates a MU-MIMO spatial configuration value and a two bit reserved field 904 for a station associated with the sharing AP or shared AP identified by the AID11 participating in the CBF. In another embodiment, a per-user information field 906 may be 17-20 bits and not include a spatial configuration field and the MU-MIMO spatial configuration value may be signaled in a common information field or spatial user information field of the CBF trigger frame 600. The field 906 may also include a station ID field to identify a station associated with the sharing AP or shared AP participating in the CBF. In some embodiments, the per-user information field 906 associated with two users (40 bits) may be combined to fit in a UHR variant user information field.

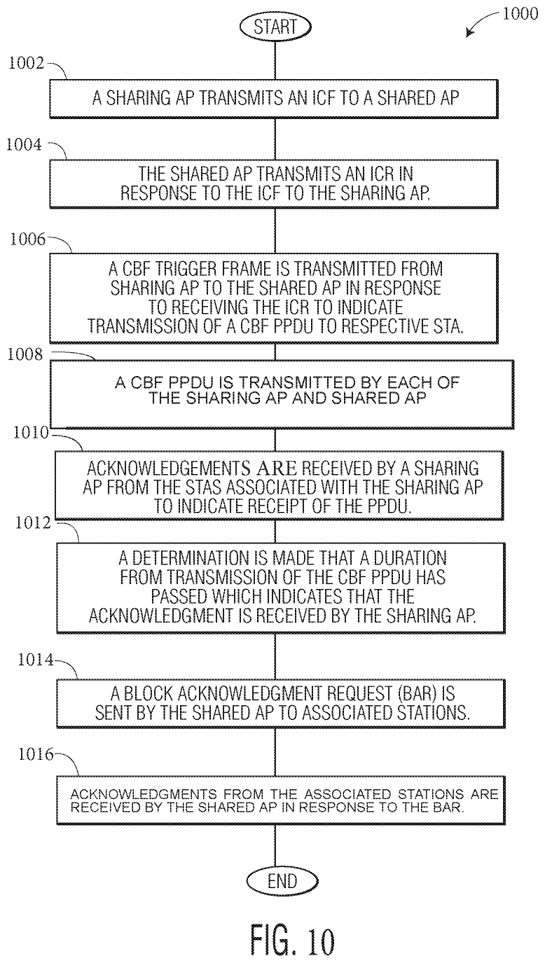

FIG. 10 is a flow chart 1000 of functions associated with defining a frame exchange sequence between a sharing AP and shared AP for CBF transmission and between the APs and associated stations for CBF transmission accordance with one or more embodiments. The functions may be performed by one or more of the sharing AP and shared AP.

At 1002, a sharing AP transmits an ICF to a shared AP. The ICF may be used to indicate a configuration of a sharing AP for performing CBF. At 1004, the shared AP transmits an ICR in response to the ICF to the sharing AP. The ICR may indicate a configuration of the shared AP associated with the CBF. At 1006, a CBF Trigger frame is transmitted from sharing AP to the shared AP in response to receiving the ICR to indicate transmission of a CBF PPDU to respective STA. The CBF may define a configuration of a PPDU of the CBF. At 1008, a CBF PPDU is transmitted by each of the sharing AP and shared AP. The CBF PPDU is transmitted in accordance with CBF based on receiving the CBF trigger frame. At 1010, acknowledgements are received by the sharing AP from the STAs associated with a sharing AP to indicate receipt of the PPDU. At 1012, a determination is made that a duration T from transmission of the CBF PPDU has passed which indicates that the acknowledgment is received by the sharing AP. The duration for the shared AP to wait may be indicated in a special user information field of the ICF frame in one or more embodiments. At 1014, a block acknowledgment request (BAR) is sent by the shared AP to associated stations. The BAR is a request for associated stations to indicate whether the CBF PPDU is received. At 1016, acknowledgments from the associated stations are received by the shared AP in response to the BAR.

In one embodiment, a method for multi-access point (AP) coordination during a transmit opportunity (TXOP) in accordance with Institute of Electrical and Electronics Engineers (IEEE) 802.11 protocol is disclosed. The method comprises: transmitting by a sharing AP an initial control frame (ICF) to indicate a coordinated beamforming (CBF) request; receiving, by the sharing AP, an initial control response (ICR) from a shared AP which indicates to perform coordinated beamforming; transmitting by the sharing AP, a CBF trigger frame which causes the shared AP and sharing AP to transmit respective CBF physical layer protocol data units (PPDUs) to associated stations; transmitting, by the shared AP, a block acknowledgment request (BAR) to associated stations to cause the associated stations to transmit a respective acknowledgement to the PPDU; and receiving, by the shared AP, the acknowledgements to the BAR. In one or more embodiments, the method further comprises determining, by the shared AP, that a predetermined time has passed after transmission of the CBF PPDUs, the predetermined time indicative of a duration for the sharing AP to receive acknowledgements to the CBF PPDU transmitted to the associated stations of the sharing AP and which is used to determine when to transmit the BAR. In one or more embodiments, a format of the CBF trigger frame is defined by a buffer status report poll (BSRP) non-trigger based (NTB) format trigger type in the trigger frame. In one or more embodiments, the ICF defines an uplink (UL) bandwidth field which indicates a bandwidth of the ICR, the ICF having a BSRP NTB format and the ICR having a multi-station block acknowledgment format. In one or more embodiments, the transmitted CBF PPDUs has the same bandwidth of the ICR. In one or more embodiments, the ICF defines a duration of the CBF PPDUs in an uplink length field. In one or more embodiments, the ICF defines in an UL bandwidth extension field of a special user information field having an association ID 12 (AID12) field comprising 2007 a bandwidth of the CBF PPDUs. In one or more embodiments, the ICF defines in a duration field of a special user information field having an AID12 field comprising a shared AP ID a duration for the sharing AP to receive acknowledgements to the CBF PPDU transmitted to the associated stations of the sharing AP which is used to determine when to transmit the BAR. In one or more embodiments, the duration is in terms of a number of OFDM symbols. In one or more embodiments, the ICF defines a special user information field with an AID12 field comprising a shared AP ID and fields that define parameters of the CBF PPDUs. In one or more embodiments, the ICF defines a user information field with an AID12 field comprising a station ID and parameters of a station with the station ID associated with the sharing AP which receives the CBF PPDUs. In one or more embodiments, the ICR includes a per AID TID information field indicating in an AID11 field a selected station of the shared AP, an acknowledgment type field, and traffic identifier (TID) field with reserved bits that indicate a number of spatial streams, a modulation and coding (MCS) scheme, and a 2×LDPC for the selected station. In one or more embodiments, the ICR includes a per AID TID information field indicating in an AID11 field a selected station of the shared AP, an acknowledgment type field, and TID field with reserved bits that indicate a PPDU duration, whether extra long training fields are to be used by the shared AP, and number of users of the selected station. In one or more embodiments, fields of the CBF trigger frame define parameters of the CBF PPDUs. In one or more embodiments, the CBF trigger frame is defined to have a special user information field set to zero and a UHR reserved field set to indicate CBF. In one or more embodiments, the trigger frame includes a user information field indicating a modulation coding scheme (MCS) for a station participating in the CBF and a low density parity check code (LDPC) parameter for the station. In one or more embodiments, the trigger frame comprises a user information field indicating a multi-user multiple input multiple output (MIMO) spatial configuration value. In one or more embodiments, the trigger frame comprises a user information field indicating user information for two users and an indication of a MU-MIMO spatial configuration value which is shared by the two users, the users being stations participating in the CBF. In one or more embodiments, the trigger frame comprises a user information field having 22 bits and reserved bits and comprising a four bit field indicating a MU-MIMO spatial configuration value.

In another embodiment, a system for multi-access point (AP) coordination during a transmit opportunity (TXOP) in accordance with Institute of Electrical and Electronics Engineers (IEEE) 802.11 protocol is disclosed. The system comprises a sharing AP arranged to transmit an initial control frame (ICF) to indicate a coordinated beamforming (CBF) request; receive an initial control response from a shared AP which indicates to perform CBF; transmit a CBF trigger frame which causes the shared AP and sharing AP to transmit respective CBF physical layer protocol data units (PPDUs) to associated stations; and a shared AP arranged to transmit a block acknowledgment request (BAR) to associated stations to cause the associated stations to transmit a respective acknowledgement to the CBF PPDUs; and receive the acknowledgements to the BAR. In one or more embodiments, the shared AP is further arranged to determine that a predetermined time has passed after transmission of the CBF PPDUs, the predetermined time indicative of a duration for the sharing AP to receive acknowledgements to the CBF PPDU transmitted to the associated stations of the sharing AP and the ICF defines in a duration field of a special user information field having an AID12 of the shared AP the duration which is used to determine when to transmit the BAR.

In yet another embodiment, a shared AP arranged to perform multi-access point (AP) coordination during a transmit opportunity (TXOP) in accordance with Institute of Electrical and Electronics Engineers (IEEE) 802.11 protocol is disclosed. The shared AP is arranged to receive an initial control frame (ICF) from the sharing AP; transmit an initial control response (ICR) from a sharing AP to the shared AP which indicates to perform coordinated beamforming in response to receiving the initial control frame (ICF) from the sharing AP; transmit a CBF physical layer protocol data unit (PPDU) to associated stations; determining that a predetermined time has passed indicative of a duration of an acknowledgement to the CBF PPDU received by associated stations of the sharing AP; transmit a block acknowledgment request (BAR) to associated stations; and receive acknowledgements to the BAR. In one or more embodiments, the shared AP is further arranged to determine that a predetermined time has passed after transmission of the CBF PPDUs, the predetermined time indicative of a duration for the sharing AP to receive acknowledgements to the CBF PPDU transmitted to the associated stations of the sharing AP and the ICF defines in a duration field of a special user information field having an AID12 of the shared AP the duration which is used to determine when to transmit the BAR.

A few implementations have been described in detail above, and various modifications are possible. The disclosed subject matter, including the functional operations described in this specification, can be implemented in electronic circuit, computer hardware, firmware, software, or in combinations of them, such as the structural means disclosed in this specification and structural equivalents thereof: including potentially a program operable to cause one or more content processing apparatus such as a processor to perform the operations described (such as a program encoded in a non-transitory computer-readable communication medium, which can be a memory device, a storage device, a machine-readable storage substrate, or other physical, machine readable communication medium, or a combination of one or more of them).

While this specification contains many specifics, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed. Other implementations fall within the scope of the following claims.

What is claimed is:

1. A method for multi-access point (AP) coordination during a transmit opportunity (TXOP) in accordance with Institute of Electrical and Electronics Engineers (IEEE) 802.11 protocol, the method comprising:
transmitting by a sharing AP an initial control frame (ICF) to indicate a coordinated beamforming (CBF) request;
receiving, by the sharing AP, an initial control response (ICR) from a shared AP which indicates to perform coordinated beamforming;
transmitting by the sharing AP, a CBF trigger frame which causes the shared AP and sharing AP to transmit respective CBF physical layer protocol data units (PPDUs) to associated stations;
transmitting, by the shared AP, a block acknowledgment request (BAR) to associated stations to cause the associated stations to transmit a respective acknowledgement to the PPDU; and
receiving, by the shared AP, the acknowledgements to the BAR.

2. The method of claim 1, further comprising determining, by the shared AP, that a predetermined time has passed after transmission of the CBF PPDUs, the predetermined time indicative of a duration for the sharing AP to receive acknowledgements to the CBF PPDU transmitted to the associated stations of the sharing AP and which is used to determine when to transmit the BAR.

3. The method of claim 1, wherein a format of the CBF trigger frame is defined by a buffer status report poll (BSRP) non-trigger based (NTB) format trigger type in the trigger frame.

4. The method of claim 1, wherein the ICF defines an uplink (UL) bandwidth field which indicates a bandwidth of the ICR, the ICF having a BSRP NTB format and the ICR having a multi-station block acknowledgment format.

5. The method of claim 4, wherein the transmitted CBF PPDUs has the same bandwidth of the ICR.

6. The method of claim 1, wherein the ICF defines a duration of the CBF PPDUs in an uplink length field.

7. The method of claim 1, wherein the ICF defines in an UL bandwidth extension field of a special user information field having an association ID 12 (AID12) field comprising 2007 a bandwidth of the CBF PPDUs.

8. The method of claim 1, wherein the ICF defines in a duration field of a special user information field having an AID12 field comprising a shared AP ID a duration for the sharing AP to receive acknowledgements to the CBF PPDU transmitted to the associated stations of the sharing AP which is used to determine when to transmit the BAR.

9. The method of claim 8, wherein the duration is in terms of a number of OFDM symbols.

10. The method of claim 1, wherein the ICF defines a special user information field with an AID12 field comprising a shared AP ID and fields that define parameters of the CBF PPDUs.

11. The method of claim 1, wherein the ICF defines a user information field with an AID12 field comprising a station ID and parameters of a station with the station ID associated with the sharing AP which receives the CBF PPDUs.

12. The method of claim 1, wherein the ICR includes a per AID TID information field indicating in an AID11 field a selected station of the shared AP, an acknowledgment type field, and traffic identifier (TID) field with reserved bits that indicate a number of spatial streams, a modulation and coding (MCS) scheme, and a 2×LDPC for the selected station.

13. The method of claim 1, wherein the ICR includes a per AID TID information field indicating in an AID11 field a selected station of the shared AP, an acknowledgment type field, and TID field with reserved bits that indicate a PPDU duration, whether extra long training fields are to be used by the shared AP, and number of users of the selected station.

14. The method of claim 1, wherein fields of the CBF trigger frame define parameters of the CBF PPDUs.

15. The method of claim 1, wherein the CBF trigger frame is defined to have a special user information field set to zero and a UHR reserved field set to indicate CBF.

16. The method of claim 1, wherein the trigger frame includes a user information field indicating a modulation coding scheme (MCS) for a station participating in the CBF and a low density parity check code (LDPC) parameter for the station.

17. The method of claim 1, wherein the trigger frame comprises a user information field indicating a multi-user multiple input multiple output (MIMO) spatial configuration value.

18. The method of claim 1, wherein the trigger frame comprises a user information field indicating user information for two users and an indication of a MU-MIMO spatial configuration value which is shared by the two users, the users being stations participating in the CBF.

19. The method of claim 1, wherein the trigger frame comprises a user information field having 22 bits and reserved bits and comprising a four bit field indicating a MU-MIMO spatial configuration value.

20. A system for multi-access point (AP) coordination during a transmit opportunity (TXOP) in accordance with Institute of Electrical and Electronics Engineers (IEEE) 802.11 protocol, the system comprising:
a sharing AP arranged to transmit an initial control frame (ICF) to indicate a coordinated beamforming (CBF) request; receive an initial control response from a shared AP which indicates to perform CBF; transmit a CBF trigger frame which causes the shared AP and sharing AP to transmit respective CBF physical layer protocol data units (PPDUs) to associated stations; and
a shared AP arranged to transmit a block acknowledgment request (BAR) to associated stations to cause the associated stations to transmit a respective acknowledgement to the CBF PPDUs; and receive the acknowledgements to the BAR.

21. The system of claim 20, wherein the shared AP is further arranged to determine that a predetermined time has passed after transmission of the CBF PPDUs, the predetermined time indicative of a duration for the sharing AP to receive acknowledgements to the CBF PPDU transmitted to the associated stations of the sharing AP and the ICF defines in a duration field of a special user information field having an AID12 of the shared AP the duration which is used to determine when to transmit the BAR.

22. A shared AP arranged to perform multi-access point (AP) coordination during a transmit opportunity (TXOP) in accordance with Institute of Electrical and Electronics Engineers (IEEE) 802.11 protocol by receiving an initial control frame (ICF) from the sharing AP; transmitting an initial control response (ICR) from a sharing AP to the shared AP which indicates to perform coordinated beamforming in response to receiving the initial control frame (ICF) from the sharing AP; transmitting a CBF physical layer protocol data unit (PPDU) to associated stations; determining that a predetermined time has passed indicative of a duration of an acknowledgement to the CBF PPDU received by associated stations of the sharing AP; transmitting a block acknowledgment request (BAR) to associated stations; and receiving acknowledgements to the BAR.

23. The shared AP of claim 22, wherein the shared AP is further arranged to determine that a predetermined time has passed after transmission of the CBF PPDU, the predetermined time indicative of a duration for the sharing AP to receive acknowledgements to the CBF PPDU transmitted to the associated stations of the sharing AP and the ICF defines in a duration field of a special user information field having an AID12 of the shared AP the duration which is used to determine when to transmit the BAR.
